(19) United States
(12) Patent Application Publication
(10) Pub. No.: US 2013/0222581 A1
(43) Pub. Date: Aug. 29, 2013

(54) Game/Surveillance Camera With a 360 Degree Field of View

(71) Applicants: Jerry Wydner, Danville, AL (US); Johnny Wydner, Danville, AL (US); Jim Barta, Hartselle, AL (US)

(72) Inventors: Jerry Wydner, Danville, AL (US); Johnny Wydner, Danville, AL (US); Jim Barta, Hartselle, AL (US)

(73) Assignee: The Hunter Safety System, Inc., Danville, AL (US)

(21) Appl. No.: 13/405,464

(22) Filed: Feb. 27, 2012

(51) Int. Cl. H04N 7/18

(52) U.S. Cl. 348/143; 348/E07.085

(57) ABSTRACT

A game and/or surveillance camera for taking digital images in a 360° view has been developed. The camera includes camera housing for a digital camera and a multiple camera lens arranged around the exterior of the camera housing, where the lens provide a combined 360° field of view.

### FIELD OF THE INVENTION

The invention relates generally to hunting and/or surveillance equipment. More specifically, the present invention relates to a game/surveillance camera with a 360° degree field of view.

### BACKGROUND ART

In scouting hunting locations, hunters have begun using cameras to detect game in promising locations for future hunts. The cameras are typically digital cameras that are mounted on a tree. A motion detector is used to activate the camera and take a picture of the subject. However, many game animals, such as deer, travel in groups so such a camera would not pick up any additional game out of the field of view of the camera. Also, since animals meander, a large percentage of game that are on the sides or behind a prior art camera are not being viewed. Additionally, if the game is moving quickly through the field of view, it may only partially appear on the picture or not at all. Consequently, it is advantageous to provide a game/surveillance camera with a 360° field of view.

### SUMMARY OF THE INVENTION

In some aspects, the invention relates to a game/surveillance camera for taking photographs in a 360° view, comprising: a camera housing holding a digital camera; four separate camera lens for the camera that are arranged equidistantly around the exterior of the camera housing, where each lens has a 90° field of view; an infrared game/subject detector located on the exterior of the camera housing that activates the digital camera; a bank of LED lights that provide flash illumination upon activation of the digital camera; an SD card that stores photographs taken by the activated digital camera; a weather shield located over the top of the camera housing; three extendable support legs attached to the bottom of the camera housing, where the length of each support leg is independently adjustable; an adjustment collar that controls the extension of the support legs; and a cylindrically shaped battery case that extends from the bottom of the camera housing, where the battery case holds a plurality of batteries that provide power for the game/surveillance camera.

In other aspects, the invention relates to a game/surveillance camera for taking digital images in a 360° view, comprising: a camera housing for a digital camera; and a plurality of camera lens arranged around the exterior of the camera housing, where the lens provide a combined 360° field of view.

In other aspects, the invention relates to a game/surveillance camera for taking digital images in a 360° view, comprising: a camera housing for a digital camera; and means for, obtaining a digital photograph with a plurality of camera lens arranged to provide a combined 360° field of view.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a frontal view of a game/surveillance camera with the legs collapsed in accordance with one embodiment of the present invention.

FIG. 2 shows a frontal view of a game/surveillance camera with a battery housing in accordance with one embodiment of the present invention.

FIG. 3 shows a frontal view of a game/surveillance camera with the legs extended in accordance with one embodiment of the present invention.

FIG. 4 shows an overhead view of a game/surveillance camera with the legs extended in accordance with one embodiment of the present invention.

FIG. 5 shows an overhead cross section view of a game/surveillance camera in accordance with one embodiment of the present invention.

### DETAILED DESCRIPTION

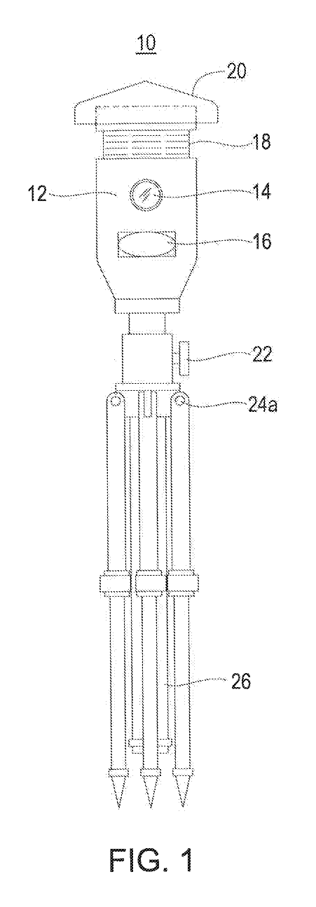

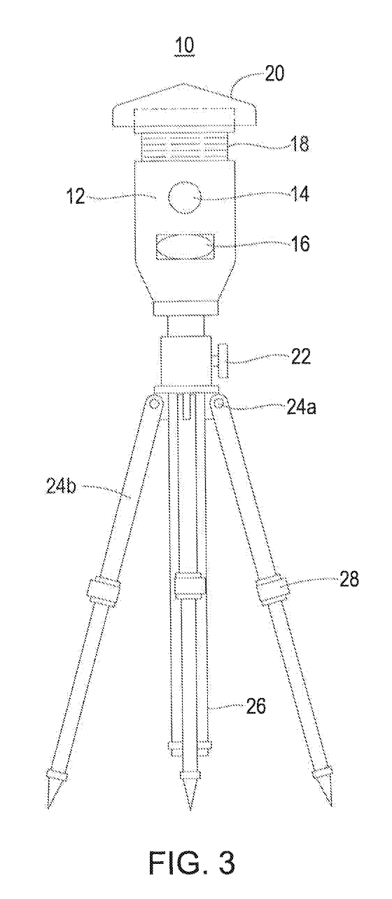

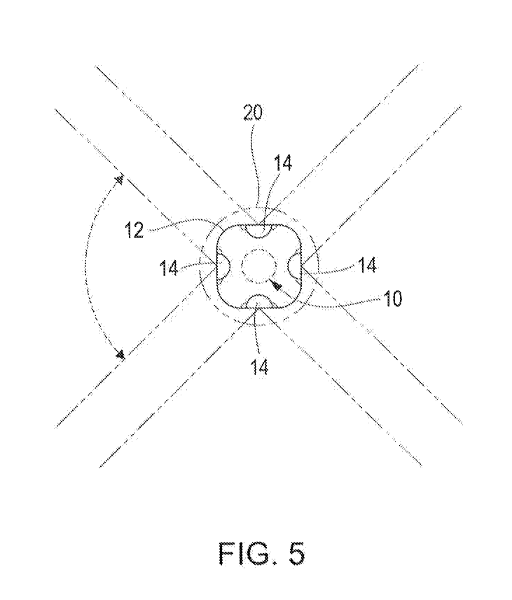

A game/surveillance camera with a 360° degree field of view has been developed. FIG. 1 shows a frontal view of one embodiment of the present invention with the legs collapsed. FIG. 3 shows a similar view with the legs extended. This embodiment of the game/surveillance camera 10 includes a camera housing 12 that holds a digital camera. The housing 12 has four separate camera lens 14 that are arranged equidistantly around the exterior of the camera housing 12. This arrangement is shown in the overhead view of FIG. 5. In this embodiment, each lens has an approximate field of view of 90°. Therefore, the combined lens will cover a full 360° field of view. While this embodiment shows 4 lenses, it should be understood that other numbers of lenses could be used to achieve a full 360° field of coverage. In the present embodiment, the invention uses 4 separate 90° lens with a 2 mm focal length. The photographs from each lens are transmitted to a single processor located in the camera. The processor may merge all of the photographs into a “panoramic view” of 360° around the camera.

This embodiment also includes an infrared game/subject detector 16 that activates the camera when subject is detected within camera range. Also included is a bank of light emitting diode (LED) lights 18 that provide flash illumination in low light conditions. A weather shield 20 is located on top of the housing 12 to protect it from the elements.

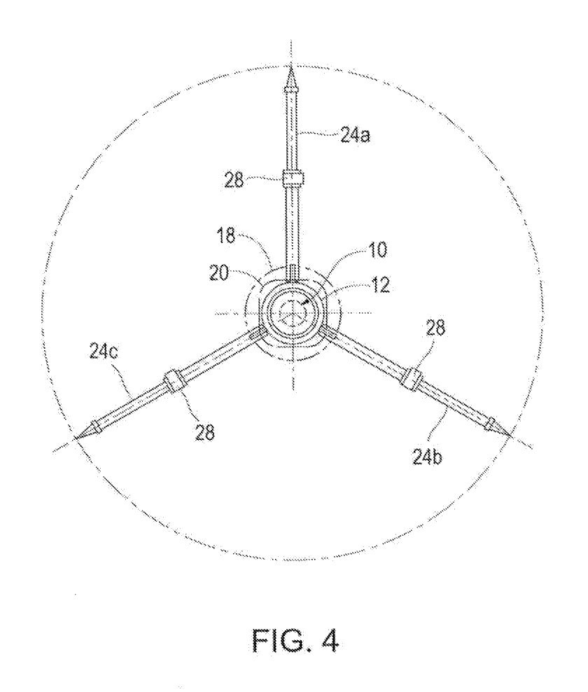

In this embodiment, the game/surveillance camera 10 is supported by three separate legs 24a-24c. The legs 24a-24c may be collapsed for carrying the camera 10 as shown in FIG. 1 or the legs 24a-24c may be extended for placing the camera 10 in use as shown in FIG. 3. While this embodiment shows 3 legs, it should be understood that other numbers of legs could be used to provide a stable platform for the camera. FIG. 4 shows an overhead view of the legs 24a-24c in an extended position. The position of the legs 24a-24c is controlled by adjustment collar 22 with a screw type mechanism that allows the legs to be extended when loose and, tightened to hold them in place once the desired extension is reached. Additionally, each leg 24a-24c may be independently lengthened or shortened with a leg extension collar 28. The extension collar 28 controls the telescopic lengthening or shortening of the leg. Since the length of each leg is adjustable independent of each other leg, the camera 10 may be placed on uneven ground while maintaining a level orientation.

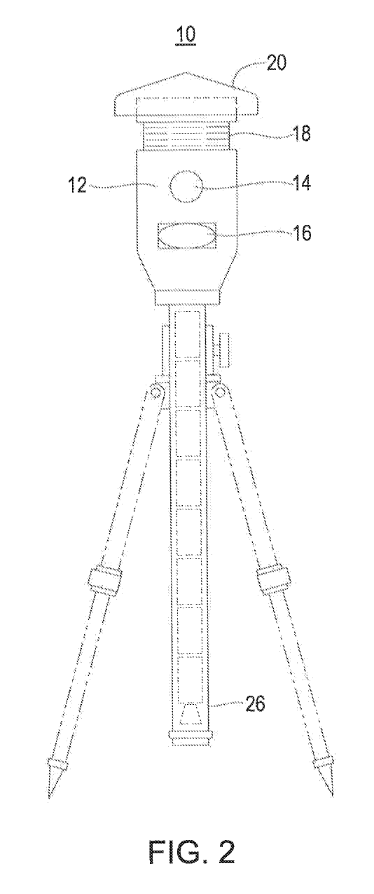

Another feature of this embodiment is the battery case 26 as shown in FIG. 2. As shown, the battery case 26 is cylindrically shaped and attached below the camera housing 12. It holds multiple batteries that power the camera 10. In this embodiment, the battery case holds 8 separate “C-cell” batteries. However, the case could hold different numbers of individual batteries and batteries of different types and sizes in other embodiments. This case has the advantage of providing a greater number of batteries that will provide a longer power supply to the invention. This will prevent the user from making frequent visits to an emplaced camera to change out the batteries. Also, the case may be vertically adjusted with the adjustment collar.

Other embodiments of the present invention may include a different number of extendable legs for the camera. For example, four or six legs could be used instead of three in order to provide greater stability. Additionally, a single leg could be used for the camera where the single leg is driven into the ground similar to a post or pole. In such a single leg embodiment, the battery case could be located in the interior of the single leg.

In other embodiments, the game/subject detector could be a standard motion detector that is well known to one of ordinary skill In the art. Additionally, the illumination mechanism could use an alternative method to LEDs for providing a flash in low light conditions. Alternatively, the camera could use night vision or thermal imaging instead of or in addition to digital photography. In some embodiments, the digital photographs are stored on a secure digital (SD) card for later retrieval. In other embodiments, the camera may include a global positioning system (GPS) capability to allow the user to precisely locate and record the location of the camera. This is particularly useful if multiple cameras were placed in a hunting area. Another feature of the invention may be an electronic password that prevents unauthorized access to the camera's photographs and any other data. This would help deter theft of the game/surveillance cameras.

While the embodiment shown uses a standard camera lens, other types of lens could be used. For example, a wide angle lens or “fish eye” lens could be used to provide an even greater field of view. This may result in fewer numbers of lenses being used by the camera or the wider angle lens may be used in the same numbers to provide overlapping fields of view.

A key advantage of the present invention is the ability to provide a 360° image of the area surrounding the camera once the presence of game animals/subjects are detected by the camera. In this invention, once the game/subject is detected, the camera and LED (if needed) is activated and a digital photograph is taken from each lens simultaneously. However, the lens on certain sectors may be deactivated by the user if its images are not needed in some embodiments. For example, if one of the lenses is blocked by a tree or other object, that lens may be deactivated by the user. In still other embodiments, the camera may take digital video images upon activation instead of still photographs. In such an embodiment, the video may run for a pre-determined amount of time before shutting off. Alternatively, the video may run for as long as the presence of game/subject is detected by the camera. Also, the camera may include a digital recorder to record audio of the game/subject.

In other embodiments, the camera may include weather sensors to record the environmental conditions (such as time, date, temperature, wind, precipitation, humidity, visibility, etc.) when the photographs were made. Other features of the invention include the capability of the invention to upload its photographs and other data to a remote user by a wireless connection. In some embodiments, the photographs and data may be stored remotely. The user would be able to download (via the internet, mobile device app, etc.), view and store the photographs and/or data from the camera and save it to electronic storage. In some embodiments, the digital photographs and related data may be automatically downloaded and stored remotely from the camera. This will allow the user to retrieve the data even if the camera is lost, damaged or stolen. If multiple cameras were located on a piece of property, a database of long term game/subject data could be collected and analyzed for later use in hunting or game management.

In other embodiments, the camera could be used as a home or site security monitor to detect and record the presence of an intruder. The camera could be camouflaged to look like common items such as a birdhouse, bird feeder, nightlight, etc. in order to be unobtrusive.

While the invention has been described with respect to a limited number of embodiments, those skilled in the art, having benefit of this disclosure, will appreciate that other embodiment can be devised which do not depart from the scope of the invention as disclosed here. Accordingly, the scope of the invention should be limited only by the attached claims.

What is claimed is:

1. A game/surveillance camera for taking photographs in a 360° view, comprising:
a) a camera housing holding a digital camera;
b) four separate camera lens for the camera that are arranged equidistantly around the exterior of the camera housing, where each lens has a 90° field of view;
c) an infrared game/subject detector located on the exterior of the camera housing that activates the digital camera;
d) a bank of LED lights that provide flash illumination upon activation of the digital camera;
e) an SD card that stores photographs taken by the activated digital camera;
f) a weather shield located over the top of the camera housing;
g) three extendable support legs attached to the bottom of the camera housing, where the length of each support leg is independently adjustable;
h) an adjustment collar that controls the extension of the support legs; and
i) an cylindrically shaped battery case that extends from the bottom of the camera housing, where the battery case holds a plurality of batteries that provide power for the game/surveillance camera.

2. A game/surveillance camera for taking digital images in a 360° view, comprising:
a camera housing for a digital camera; and
a plurality of camera lens arranged around the exterior of the camera housing, where the lens provide a combined 360° field of view.

3. The game/surveillance camera of claim 2, further comprising:
at least one adjustable support leg extending from the bottom of the camera housing.

4. The game/surveillance camera of claim 3, further comprising:
three separate support legs extending from the bottom of the camera housing.

5. The game/surveillance camera of claim 4, where each support leg is independently telescopically adjustable in length.

6. The game/surveillance camera of claim 4, where the support legs are attached to the camera housing with an adjustment collar that extends and collapses the support legs.

7. The game/surveillance camera of claim 2, further comprising:
a game/subject detector that activates the digital camera.

8. The game/surveillance camera of claim 7, where the game/subject detector comprises a motion sensor.

9. The game/surveillance camera of claim 7, where the game/subject detector comprises an infrared sensor.

10. The game/surveillance camera of claim 2, further comprising:
a bank of LED lights that provide illumination upon activation of the digital camera.

11. The game/surveillance camera of claim 2, further comprising:
a weather shield located at the top of the camera housing.

12. The game/surveillance camera of claim 2, further comprising:
a battery housing that holds multiple batteries that power the game/surveillance camera.

13. The game/surveillance camera of claim 12, where the battery housing holds C-cell batteries.

14. The game/surveillance camera of claim 2, where the plurality of camera lens comprise 4 separate lens located equidistantly around the exterior of the camera housing, where each camera lens has a 90° field of view.

15. The game/surveillance camera of claim 2, where the camera lens comprise wide angle lens, where each wide angle lens has a field of view greater than 90°.

16. The game/surveillance camera of claim 2, where the plurality of camera lens provide overlapping fields of view.

17. The game/surveillance camera of claim 2, where digital camera records video upon activation.

18. The game/surveillance camera of claim 2, where digital camera records a photograph upon activation.

19. The game/surveillance camera of claim 2, where the camera is camouflaged as a device selected from the group consisting of a bird house, a bird feeder and a nightlight.

20. A game/surveillance camera for taking digital images in a 360° view, comprising:
a camera housing for a digital camera; and
means for obtaining a digital photograph with a plurality of camera lens arranged to provide a combined 360° field of view.
